(19) United States
(12) Patent Application Publication
(10) Pub. No.: US 2012/0018540 A1
(43) Pub. Date: Jan. 26, 2012

(54) SPRAY GUN

(75) Inventor: Richard J. Gilpatrick, Whitewater, WI (US)

(73) Assignee: Briggs & Stratton Corporation

(21) Appl. No.: 12/841,034

(22) Filed: Jul. 21, 2010

(51) Int. Cl. B05B 9/01

(52) U.S. Cl. 239/526

(57) ABSTRACT

A spray gun for controlling a pressurized flow of water from a water source includes a housing, a garden hose coupling, a spray head, a valve, a trigger, and a mechanism coupled to the trigger and the valve. The housing has a conduit extending through the housing, defining a flow path for the pressurized flow of water. The garden hose coupling is located on a first end of the conduit, and the pressurized flow of water enters the spray gun by way of the garden hose coupling. The spray head is connected to the housing on a second end of the conduit, and the pressurized flow of water exits the spray gun by way of the spray head. The valve includes at least one of a ball valve and a barrel valve, and is positioned along the conduit between the first and second ends of the conduit. The valve is rotatable relative to the conduit to open, partially close, and fully close the flow path. Movement of the trigger is received by the mechanism and converted to a rotation of the valve.

### BACKGROUND

The present disclosure relates generally to the field of spray guns, such as those that may be coupled to garden hose systems for everyday cleaning, washing, and watering applications.

Household garden hose systems may be used for a wide variety of tasks around a home. However at the water pressures supplied by a faucet or bibcock of a household plumbing system, the out-going streams from garden hoses are typically limited to a relatively low pressure, flowing at a rate of about 3 to 5 gallons per minute (gpm). The water pressure may be insufficient to effectively scrub surfaces, quickly water plants, or controllably spray distant cleaning targets. To compensate for insufficient water pressure, household garden hoses may be fitted with a wide variety of fittings and nozzles to provide a stream of water with an increased exit velocity.

Garden hose booster pumps may be used to provide extra water pressure and an increased flow rate (e.g., greater than 5 gpm) for indoor or outdoor applications, such as gardening, cleaning, or other applications. Water pressure levels produced by garden hose booster pumps are low enough that standard, conventional garden hoses may be used on the outlet of the pumps, but high enough to meet the requirements of various tasks, such as removing stuck-on plant debris from a vehicle, dried-on bird waste from a window, or spider webs from an eve of a high roof line, for example. As such, the added boost provided by a garden hose booster pump may produce water streams powerful enough to enhance performance of everyday household cleaning tasks.

### SUMMARY

One embodiment of the invention relates to a spray gun for controlling a pressurized flow of water from a water source. The spray gun includes a housing, a garden hose coupling, a spray head, a valve, a trigger, and a mechanism coupled to the trigger and the valve. The housing has a conduit extending through the housing, defining a flow path for the pressurized flow of water. The garden hose coupling is located on a first end of the conduit, and the pressurized flow of water enters the spray gun by way of the garden hose coupling. The spray head is connected to the housing on a second end of the conduit, and the pressurized flow of water exits the spray gun by way of the spray head. The valve includes at least one of a ball valve and a barrel valve, and is positioned along the conduit between the first and second ends of the conduit. The valve is rotatable relative to the conduit to open, partially close, and fully close the flow path. Movement of the trigger is received by the mechanism and converted to a rotation of the valve.

Another embodiment of the invention relates to a spray gun that includes a housing, a garden hose coupling, a spray head, a valve, a trigger, and gearing. The housing has a conduit extending through the housing, and defining a water flow path for a pressurized flow of water. The garden hose coupling is located on a first end of the conduit, and the pressurized flow of water enters the spray gun by way of the garden hose coupling. The spray head is connected to the housing on a second end of the conduit, and the pressurized flow of water exits the spray gun by way of the spray head. The water flow path curves less than 45-degrees between the first and second ends of the conduit. The valve is positioned along the conduit between the first and second ends of the conduit for controlling the pressurized flow of water along the water flow path. The gearing is positioned between the trigger and the valve such that operation of the trigger moves the valve by way of the gearing.

Yet another embodiment of the invention relates to spray gun that includes a housing, a hose coupling, a spray head, a valve, and a handle coupled to the housing. The spray gun further includes a chemical storage container, a chemical-delivery conduit, a first trigger, and a second trigger. The housing has a water conduit extending through the housing defining a water flow path for a pressurized flow of water. The hose coupling is positioned on a first end of the water conduit, and the pressurized flow of water enters the spray gun by way of the hose coupling. The spray head is connected to the housing on a second end of the water conduit, and the pressurized flow of water exits the spray gun by way of the spray head. The valve is positioned along the water conduit between the first and second ends of the water conduit for controlling the pressurized flow of water along the water flow path. The first trigger is moveable relative to the handle, and designed to operate the valve. The chemical storage container is selectively connected to the housing, and the chemical-delivery conduit extends between the chemical storage container and the water flow path. The second trigger is moveable relative to the handle, and designed to control a flow of chemicals passing through the chemical-delivery conduit and to the water flow path.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a garden hose system according to an exemplary embodiment of the invention.

FIG. 2 is a perspective view of a booster pump system for a garden hose according to an exemplary embodiment of the invention.

FIG. 3 is a perspective view of a spray gun according to an exemplary embodiment of the invention.

FIG. 4 is a top view of the spray gun of FIG. 3.

FIG. 5 is a side view of a handle of a spray gun according to another exemplary embodiment of the invention.

FIG. 6 is a side view of a spray gun according to yet another exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

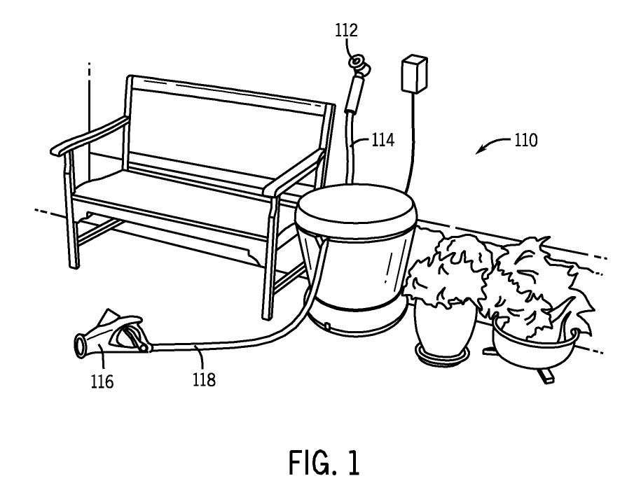

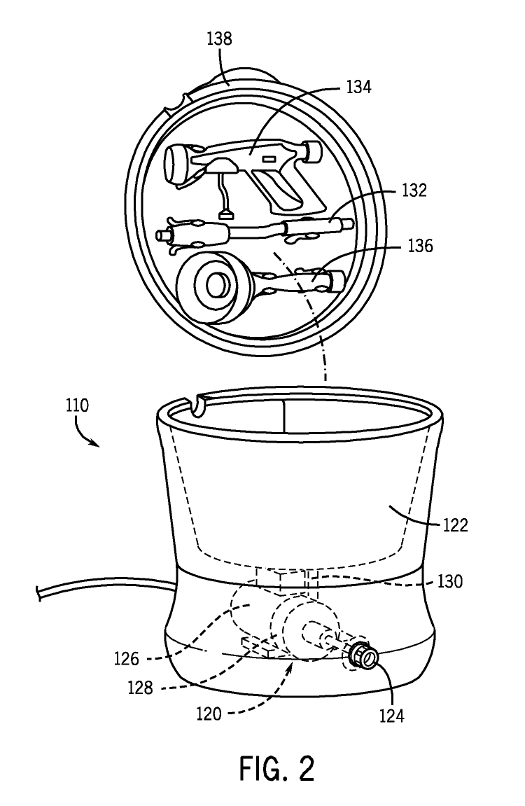

Referring to FIGS. 1-2, a garden hose system 110 is useful for everyday household tasks, such as cleaning a patio, watering plants, washing a car, and the like. The garden hose system includes water source, such as a faucet 112 or bibcock coupled to municipal water or a well water supply. A conventional garden hose 114 may then be coupled to the faucet 112 to deliver water from the faucet 112 to a sprayer, such as a sprinkler or a spray gun 116 coupled to an end of a hose 118. In some such embodiments, an intermediate booster pump 120 (FIG. 2) is coupled in series with the garden hoses 114, 118, while in other embodiments the spray gun 116 is coupled directly to the water supply by way of one or more of the hoses 114, 118, without additional flow boosting.

According to an exemplary embodiment, the garden hose system 110 includes a garden hose storage container 122 coupled to the booster pump 120, such that the booster pump 120 provides weight to the base of the storage container 122. In such an embodiment, the first garden hose 114 (FIG. 1) supplies water from the faucet 112 to an inlet 124 of the booster pump 120. An electric motor 126 then powers a centrifugal pump 128 that further pressurizes the flow of water and delivers the water to an outlet 130 of the booster pump 120. The second garden 118 hose may be coupled to the outlet, which is accessible through a base of the storage container 122, to supply water to the spray gun 116 or another sprayer, such as a spray wand 132, a different spray gun 134, or a spray brush 136, coupled to a lid 138 of the storage container 122. Other types of pumps, hoses, and accessories may be used with the systems described in this disclosure.

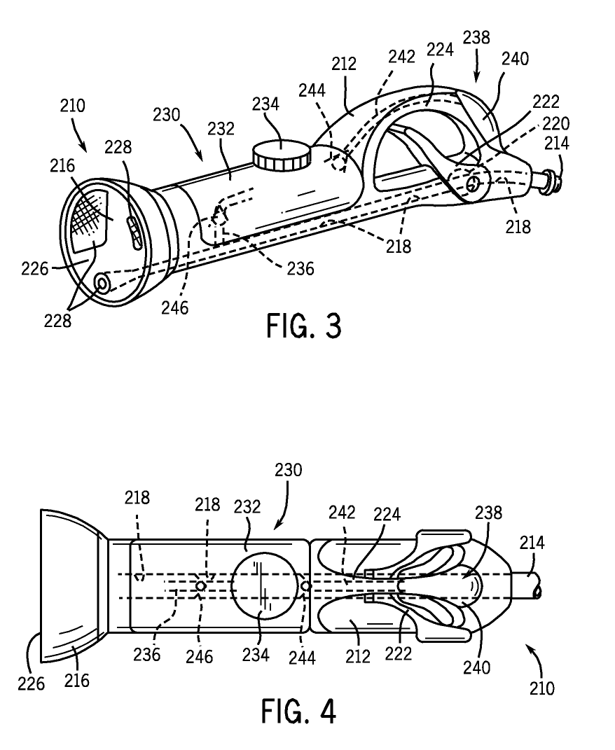

Referring to FIGS. 3-4, a spray gun 210 is configured for controlling a pressurized flow of water from a water source, such as a garden hose connected to a booster pump or an unassisted outdoor faucet (see, e.g., faucet 112, hoses 114, 118, and booster pump 120 as shown in FIG. 1). The spray gun 210 includes a housing 212 having a hose coupling 214 and a spray head 216 coupled to the housing 212. The hose coupling 214 may be a male or female hose coupling, a quick-connect hose coupling, a threaded hose coupling, a crows-foot type coupling, or another form of coupling configured to connect a garden hose or another type of conduit (e.g., pipe) to the spray gun 210. Additionally, in some embodiments, a hose coupling may be scaled differently than the hose coupling 214 (e.g., larger, smaller, longer, shorter, wider, narrower).

From the hose coupling 214, a flow path 218 of the pressurized flow of water enters the housing 212 and passes by a valve, which in some embodiments includes a valve member 220 (e.g., ball valve, barrel valve, globe valve) having an unobstructed passage through the valve member 220. When the valve member 220 is in an open position, the flow path 218 through the housing 212 continues to the spray head 216. In some such embodiments, rotation of the valve member 220 (e.g., by 90-degrees) moves the valve member 220 to a closed position, where the flow path 218 through the housing 212 is completely blocked. Furthermore, rotation of the valve member 220 from either the open or closed positions by an angle (e.g., less than 90-degrees) puts the valve member 220 in a partially-open configuration, allowing some but not the full flow to pass by the valve member 220. As such, the rate of water flowing through the spray gun 210 may be controlled by rotation of the valve member 220. In other embodiments, other forms of valves are used, such as a poppet valve, a butterfly valve, a piston valve, etc.

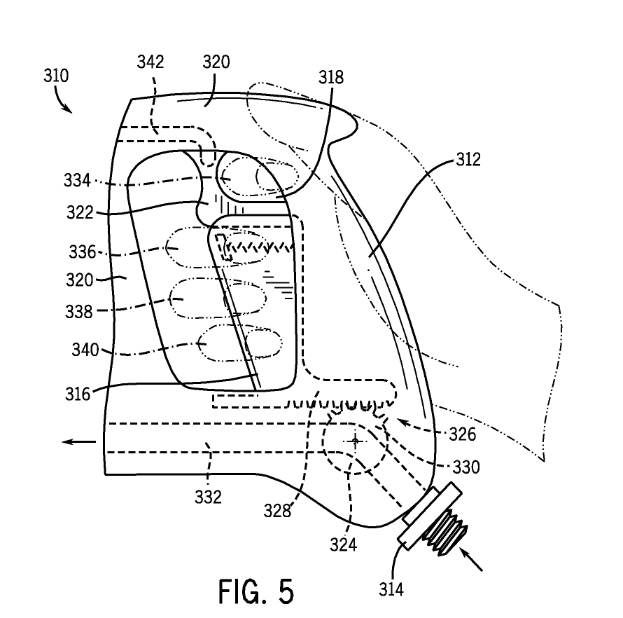

According to an exemplary embodiment, the valve member 220 may be operated by way of a trigger 222 (e.g., actuator, controller) coupled to the housing 212. In some embodiments, the trigger 222 may be actuated by a finger of an operator to move a lever. The trigger 222 may be directly fixed to the valve member 220 or may be coupled to the ball valve by way of intermediate members (see generally rack 328 and pinion 330 as shown in FIG. 5). The spray gun 210 may further include a trigger guard 224 extending at least partially around the trigger 222, particularly protecting the trigger 222 in the direction that the trigger 222 moves. In other contemplated embodiments, a trigger may be actuated by rotating or pulling a sleeve relative to the housing. Still other forms of triggers may be used.

Referring to FIGS. 3-4, when the valve member 220 is open, the pressurized flow of water may pass through the remainder of the flow path 218 to reach the spray head 216. According to an exemplary embodiment, the spray head 216 of the spray gun 210 includes a rotating nozzle 226 having various nozzle settings 228 (e.g., high flow-rate setting, low flow-rate setting). The nozzle 226 may be rotated relative to the housing 212 such that one or more of the settings 228 are aligned with the flow path 218, allowing the pressurized flow to pass though the nozzle 226 and be conditioned by the nozzle 226.

Still referring to FIGS. 3-4, the flow path 218 between the hose coupling 214 and the spray head 216 is generally straight. The geometry of the flow path 218 is intended to reduce pressure losses as the pressurized flow of water passes through the spray gun 210. In addition, use of the valve member 220 having the unobstructed passage through the valve member 220 is further intended to improve the efficiency of the spray gun 210. According to an exemplary embodiment, when the spray gun 210 is spraying, the flow path includes no obstructions separating (e.g., dividing, splitting, parsing) the pressurized flow of water. Further the flow path through the conduit is preferably substantially straight (e.g., having a 30-degree or less bend), reducing losses associated with changing the direction of the pressurized flow of water. Despite being substantially straight, in some such embodiments the flow path includes a small angle (e.g., about 15-degrees) at the inlet, which is intended to reduce the likelihood of kinks in a garden hose coupled to the inlet.

In some embodiments, the spray gun 210 includes a portion 230 of the spray gun 210 configured to support a chemical storage container 232. The container 232 may be removable or permanently fastened to the housing 212 of the spray gun 210. In the embodiment of FIGS. 3-4, the container 232 includes a removable fill cap 234, providing access for refills of the chemical contents (e.g., soap, fertilizer, pesticide, dye, etc.) of the container 232. A chemical conduit 236 couples the chemicals of the storage container 232 with the flow path 218 of the water. The chemicals provided by the chemical conduit 236 may then be mixed with the water internal to the spray gun 210, or may be added to the water after both the water and the chemicals have been separately ejected from the spray gun 210.

According to an exemplary embodiment, a pump 238 is coupled to the spray gun 210 for facilitating movement of the chemicals from the storage container 232 to the pressurized flow of water. As shown in the exemplary embodiment of FIGS. 3-4, the pump 238 is manual pump having an actuator 240 integrated with the housing 212 of the spray gun 210. In some embodiments, the actuator 240 includes an air pumping mechanism that pushes air through a conduit 242 internal to the housing 212, past a check valve 244, and into the storage container 232. Increased air pressure in the storage container 232 then pushes the chemicals from the storage container 232, past a second check valve 246 and into the pressurized flow of water.

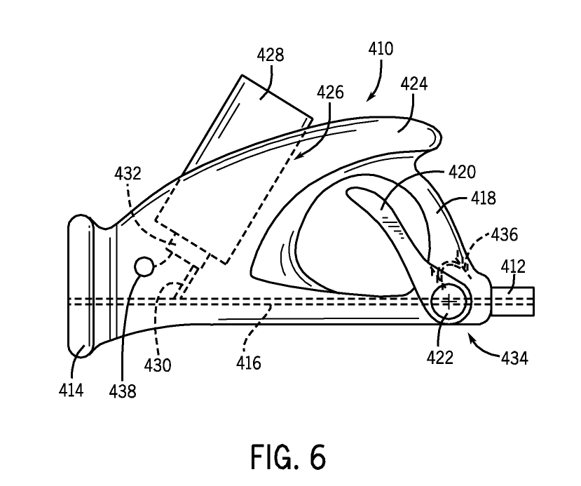

Referring now to FIG. 5, a handle 310 of a spray gun (see, e.g., spray gun 210 as shown in FIGS. 3-4) includes a housing structure 312, a hose coupling 314, a first trigger 316 and a second trigger 322. A trigger guard 320 extends around both the first and second triggers 316, 318, and an opening 318 extends behind the second trigger 318. Internal to the housing structure 312, the handle 310 includes a conduit 332 defining a flow path for water to pass through the spray gun, from the hose coupling 314 to a spray head (see, e.g., spray head 414 as shown in FIG. 6). A valve 324 (e.g., ball valve, barrel valve) is coupled in series with the conduit 332, between the hose coupling 314 and the spray head. In some embodiments the hose coupling 314 is arranged such that the conduit 332 and valve 324 are below the triggers 316, 318, which is intended to be a comfortable configuration for an operator. However, in other embodiments, the conduit and valve (i.e., flow path) are positioned above the handle (see, e.g., spray gun 134 as shown in FIG. 2).

A mechanism coupled to the first trigger 316 facilitates rotation of the valve 324. In some embodiments, the mechanism includes a gear set 326, conditioning (e.g., amplifying, reducing, filtering, converting translation to rotation and/or travel to torque, etc.) a movement of the first trigger 316 into a related movement of the valve 324. In some embodiments, the gear set 326 includes a rack 328 coupled to the first trigger 316 and a pinion 330 coupled to the valve 324 or integrally formed with the valve 324 (e.g., teeth typical of a spur gear extending from the surface of a valve member). According to an exemplary embodiment, the first trigger 316 is biased to a forward position, which corresponds to a closed position for the valve 324. Pulling of the first trigger 316 toward the rear of the handle 310 pulls the rack 328 over the pinion 330, rotating the valve 324 and opening the flow path of the conduit 332. In other embodiments, instead of the gear set 326 the mechanism includes a lever, pulleys, wheels, solenoids, sprockets, or other machine elements to condition a movement of a valve in response to movement of a trigger.

Still referring to FIG. 5, the second trigger 322 is positioned within the trigger guard 320 and includes the opening 318, above and adjacent to the first trigger 316. As such, the handle 310 is configured to be held by the operator having an index finger 334 to pull the second trigger 322 and middle, ring, and little fingers 336, 338, 340 to pull the first trigger 316. Both the trigger guard 320 and the opening 318 may help reduce the risk of unintentional pulling of the triggers 316, 318 by preventing inadvertent contact. In addition, the opening 318 provides a resting surface for the index finger 334 of the operator when the second trigger 322 is not being used.

According to an exemplary embodiment, the second trigger 322 is coupled to a rail 342 or other linkage. In some embodiments, the rail 342 is configured to communicate movement of the second trigger 322 to a system of the spray gun having a function that is separate from control the flow of water, such as a release valve for a chemical-delivery conduit to deliver chemicals to the flow of water passing through the spray gun. In some contemplated embodiments, movement of the rail 342 allows pressure from the flow of water to drive a piston, which pumps chemicals from a chemical storage tank into the flow of water. In other embodiments, the rail 342 is connected to a spray gun pump (e.g., piston pump with check valve, spray bottle pneumatic pump, etc.). Operation of the rail 342 manually drives chemicals through the chemical-delivery conduit to the water flow path, such as by pumping air into a chemical chamber, which displaces chemicals from the chemical container.

Referring to FIG. 6, a spray gun 410 includes a hose coupling 412, a spray head 414, and a conduit 416 extending between the hose coupling 412 and the spray head 414. The spray gun 410 further includes a handle 418 having a trigger 420 rotatable about a pivot 434 that is coupled to a housing 424 of the spray gun 410 below the trigger 420. According to an exemplary embodiment, the trigger 420 is coupled to a valve 422 (e.g., ball valve, barrel valve) positioned in series with the conduit 416. A spring 436 (e.g., torsion spring) biases the trigger 420 to close the valve 422. In some embodiments, the spray head 414 includes several settings, and may be adjustable by rotating the spray head 414 relative to the housing 424 (see, e.g., spray head 216 as shown in FIG. 3).

According to an exemplary embodiment, the flow path through the valve 422 is unobstructed when the valve 422 is rotated to an open position. Further, the conduit 416 is substantially straight, providing an efficient flow path through the spray gun 410. However, in other embodiments, a portion of the valve is positioned in the flow path, even when the valve is rotated to an open position (e.g., shaft of butterfly valve, poppet head, etc.). In some embodiments, the flow path includes a substantial bend (e.g., more than 60-degrees). Although shown as below the trigger 420 and handle 418, in other embodiments the conduit 416 and valve 422 are above or coincide with the trigger 420 or handle 418.

According to an exemplary embodiment, the housing 424 includes a portion 426 of the housing 424 (e.g., port, pocket, aperture) configured to receive a disposable chemical storage container 428, such as a soap bottle. Once inserted into the portion 426 of the housing 424, the chemical storage container 428 may be selectively connected to the conduit 416 by way of an auxiliary conduit 430 internal to the housing 424. In other embodiments, a reusable storage container is used.

In some embodiments, a small, battery-powered pump 432 (e.g., dual-chamber piston pump) is used to selectively move chemicals from the storage container 428, through the auxiliary conduit 430, and into water flowing through the conduit 416. A button actuator 438 for the pump 432 may be positioned on the top or side of the housing 424. In some embodiments, the pump 432 actively pushes chemicals through the auxiliary conduit 430. In other embodiments, a venturi nozzle positioned on an end of the auxiliary conduit is used to draw chemicals from the storage container into the water flow.

The construction and arrangements of the spray gun, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A spray gun for controlling a pressurized flow of water from a water source, comprising:
a housing having a conduit extending through the housing defining a flow path for the pressurized flow of water;
a garden hose coupling on a first end of the conduit, wherein the pressurized flow of water enters the spray gun by way of the garden hose coupling;
a spray head coupled to the housing on a second end of the conduit, wherein the pressurized flow of water exits the spray gun by way of the spray head;
a valve comprising at least one of a ball valve and a barrel valve, the valve positioned along the conduit between the first and second ends of the conduit, wherein the valve is rotatable relative to the conduit to open, partially close, and fully close the flow path;
a trigger; and
a mechanism coupled to the trigger and the valve,
wherein a movement of the trigger is received by the mechanism and converted to a rotation of the valve.

2. The spray gun of claim 1, wherein the mechanism uses gearing to rotate at least a portion of the valve.

3. The spray gun of claim 2, wherein the mechanism comprises a rack and pinion gear set, with the rack connected to the trigger and the pinion coupled to the valve, wherein a translation of the trigger is converted to rotation of the valve.

4. The spray gun of claim 3, wherein the conduit lengthwise along the flow path curves less than 90-degrees from the first end to the second end.

5. The spray gun of claim 4, wherein the conduit lengthwise along the flow path curves less than 45-degrees from the first end to the second end.

6. The spray gun of claim 5, wherein the conduit lengthwise along the flow path is substantially straight from the first end to the second end.

7. A spray gun, comprising:
a housing having a conduit extending through the housing and defining a water flow path for a pressurized flow of water;
a garden hose coupling on a first end of the conduit, wherein the pressurized flow of water enters the spray gun by way of the garden hose coupling;
a spray head coupled to the housing on a second end of the conduit, wherein the pressurized flow of water exits the spray gun by way of the spray head, wherein the water flow path curves less than 45-degrees between the first and second ends of the conduit;
a valve positioned along the conduit between the first and second ends of the conduit for controlling the pressurized flow of water along the water flow path;
a trigger; and
gearing positioned between the trigger and the valve such that operation of the trigger moves the valve by way of the gearing.

8. The spray gun of claim 7, wherein the flow path is substantially straight between the first and second ends of the conduit.

9. The spray gun of claim 7, wherein the valve is at least one of a ball valve and a barrel valve positioned along the water flow path.

10. The spray gun of claim 8, wherein the gearing includes a rack and pinion gear set positioned between the trigger and the valve, wherein translation of the trigger rotates at least a portion of the valve.

11. The spray gun of claim 7, further comprising:
a chemical storage container coupled to the housing;
a battery-powered pump coupled to the chemical storage container; and
a chemical-delivery conduit extending between the chemical storage container and the water flow path,
wherein the battery-powered pump directs a flow of chemicals from the chemical storage container to the water flow path by way of the chemical-delivery conduit.

12. The spray gun of claim 11, wherein the trigger is a first trigger, and the spray gun further comprises:
a second trigger for controlling the battery-powered pump, and thereby controlling the flow of chemicals through the chemical-delivery conduit from the chemical storage container to the water flow path.

13. The spray gun of claim 12, wherein the first trigger and the second trigger both extend from a same side of the open area, and both translate in the same direction.

14. The spray gun of claim 13, further comprising:
a trigger guard defining an open area within which both the first trigger and the second trigger are positioned.

15. The spray gun of claim 14, wherein the first trigger is larger than the second trigger.

16. The spray gun of claim 15, wherein the first trigger is positioned below the second trigger within the open area, such that the second trigger is configured for operation via an index finger of an operator.

17. A spray gun, comprising:
a housing having a water conduit extending through the housing defining a water flow path for a pressurized flow of water;
a hose coupling on a first end of the water conduit, wherein the pressurized flow of water enters the spray gun by way of the hose coupling;
a spray head coupled to the housing on a second end of the water conduit, wherein the pressurized flow of water exits the spray gun by way of the spray head;
a valve positioned along the water conduit between the first and second ends of the water conduit for controlling the pressurized flow of water along the water flow path;
a handle coupled to the housing;
a first trigger moveable relative to the handle and configured to operate the valve;
a chemical storage container coupled to the housing; and
a chemical-delivery conduit extending between the chemical storage container and the water flow path;
a pump coupled to the chemical storage container and the chemical-delivery conduit,
a second trigger moveable relative to the handle, wherein the pump is operated by the second trigger to direct the flow of chemicals through the chemical-delivery conduit and to the water flow path.

18. The spray gun of claim 17, wherein the pump actively pushes chemicals through the chemical-delivery conduit when actuated.

19. The spray gun of claim 18, wherein the pump is a manual pump actuated by pulling the second trigger.

20. The spray gun of claim 18, wherein the pump is a battery-powered pump configured to selectively drive chemicals through the chemical-delivery conduit.
